(19) United States
(12) Patent Application Publication
(10) Pub. No.: US 2006/0001186 A1
(43) Pub. Date: Jan. 5, 2006

(54) IOL and method of manufacturing an IOL

(76) Inventors: Gary A. Richardson, Rochester, NY (US); Ted Foos, Rochester, NY (US); Larry C. Hovey, Ontario, NY (US)

Correspondence Address: Bausch & Lomb Incorporated, One Bausch & Lomb Place, Rochester, NY, 14604-2701, US

(21) Appl. No.: 10/881,039

(22) Filed: Jun. 30, 2004

(51) Int. Cl. B29D 11/00

(52) U.S. Cl. 264/2.7; 425/406; 425/808

(57) ABSTRACT

A method, lens and assembly are disclosed for making a dual optic AIOL from a lens blank having first and second optics and at least one haptic extending therebetween larger in area than the haptic(s) of the finished AIOL. Material is removed from the semi-finished haptic to form the finished haptic of any desired configuration.

### BACKGROUND OF THE INVENTION

The present invention relates to intraocular lenses (hereinafter “IOL”) having at least one optic and at least one haptic. More particularly, in a preferred embodiment, the invention relates to an IOL blank and intermediate assembly for the manufacture of an IOL. In a further preferred embodiment, the invention relates to a method of manufacturing an IOL having first and second optics interconnected by at least one haptic, the optics being movable with respect to each other to provide accommodative effect to an eye. The invention also relates to an IOL made according to the method.

Dual optic AIOLs having first and second optics interconnected by one or more haptics are known. See, for example, Sarfarazi U.S. Pat. Nos. 5,275,623; 6,423,094 and 6,488,708. A method of manufacturing a dual optic AIOL is disclosed in copending application Ser. No. 10/445,762 filed May 27, 2003, the entire disclosure of which is incorporated herein by reference. In that application, the AIOL is injection molded using a mold insert that is removable from the mold core. The mold insert and mold core halves together form the first and second AIOL optic cavities and haptic cavities that interconnect the optic cavities. Once the mold material is introduced and cured in the mold cavity, the mold is opened and the mold insert is removed with the formed AIOL still attached thereto. A paddle arm is attached to the mold insert to assist in handling the mold insert. Since the mold material is flexible (e.g., silicone), the molded AIOL may be carefully stretched off the mold insert with the mold insert passing through the space between two haptics.

While the above described application provides an effective method of manufacturing a dual optic AIOL, it would be desirable to have a semi-finished AIOL blank from which a variety of differently sized and shaped AIOLs may be formed. It would further be desirable to have a semi-finished AIOL and mold insert assembly to facilitate further processing of the semi-finished AIOL into a finished AIOL. Although the invention is described herein in relation to an AIOL having first and second optics, it is understood the invention is applicable to single optic IOLs which may or may not provide an accommodative effect to an eye in which it is implanted.

### SUMMARY OF THE INVENTION

In a first aspect, the present invention provides a method of manufacturing an AIOL having first and second optics and at least one finished haptic extending therebetween. The method comprises the steps of forming the first and second optics with a semi-finished haptic extending therebetween which is larger than the finished haptic or haptics. The finished haptics are formed by removing or reducing a portion of the semi-finished haptic or haptics. This manufacturing method allows a semi-finished AIOL blank to be initially formed from which a variety of differently sized and shaped finished haptics may be formed. This increases efficiencies in manufacturing in that a single mold tool may be used to create the semi-finished AIOL from which the finished AIOL is made. Thus, separate mold tools need not be made for each haptic size and configuration being manufactured, thereby reducing time and cost to manufacture. The AIOL may be made from any desired and appropriate IOL material with soft materials (e.g., silicone) being preferred to allow the AIOL to be compressed and inserted through a small incision in the eye.

In another aspect, the present invention provides an AIOL blank for making a finished AIOL having first and second optics with one or more haptics extending therebetween. The AIOL blank includes at least one semi-finished haptic larger than the finished haptic or haptics of the finished AIOL. A portion of the semi-finished haptic or haptics of the AIOL blank may be removed or otherwise reduced in area to achieve the desired finished haptic size and shape.

In yet another aspect, the invention provides an assembly comprising a mold insert and an AIOL blank formed about the insert. The insert may be part of an injection mold core and cavity for molding an AIOL blank having first and second optics with at least one semi-finished haptic extending between the first and second optics. The mold insert includes first and second optical surfaces for forming the facing surfaces of the first and second optics of the finished AIOL. The haptic or haptics of the AIOL extend about the insert and interconnect the first and second AIOL optics. Thus, the surfaces of the insert extending between the first and second optical surfaces thereof form the inside surfaces of the AIOL haptic or haptics. The mold core in which the mold insert is positioned in the mold machine forms the remaining surfaces of the AIOL.

After introducing and curing the mold material in the mold cavity, the mold is opened and the mold insert is removed therefrom with the IOL blank formed about and remaining with the insert. The mold insert may thereafter be used as a fixture for holding the AIOL blank when performing any desired processing operations on the AIOL blank (e.g., processing the haptics into their finished form, polishing, extraction, hydration, inspection etc.). At any desired stage, the AIOL may be removed from the mold insert (i.e., before or after one or more subsequent processing steps). This may be done by molding the AIOL with a side opening and carefully stretching the soft AIOL off of the insert, for example. In this regard, the mold insert may be attached to a handle that forms the opening in the semi-finished haptic and wherethrough the mold insert is retracted. Alternatively, the semi-finished haptic may not include a molded-in opening, but rather an opening is cut into the semi-finished haptic while the AIOL is still on the mold insert. The AIOL may then be stretched off the mold insert by retracting the mold insert through the cut opening. Alternatively, one or all the haptics may be cut from the semi-finished haptic while the AIOL remains on the insert. Other possible AIOL-mold insert separation techniques include deforming, collapsing or destroying (sacrificing) the mold insert itself, leaving the AIOL intact and unharmed. In this regard, the mold insert may be made from a variety of materials acceptable for this purpose.

It may also be desirable to form semi-finished optic(s) that may be reduced in area (e.g., diameter) to form the finished optic(s) in a manner similar to the formation of the finished haptics from the semi-finished haptic.

### BRIEF DESCRIPTION OF THE DRAWING

FIG. 1 is a partial cross-sectional view of a human eye including the natural crystalline lens positioned within a posterior chamber capsular bag;

FIG. 2 is a partial cross-sectional view of a human eye as depicted in FIG. 1 where the natural crystalline lens has been replaced with an open AIOL in accordance with one preferred embodiment of the invention to restore a patient's natural, accommodative, vision following extracapsular surgery;

FIG. 3 is a perspective view of an open chamber AIOL having three elliptically shaped haptics extending between an anterior AIOL optic and a posterior AIOL optic in accordance with one preferred embodiment of the invention;

FIG. 4 is a end view of the IOL system, as depicted in FIG. 3;

FIG. 5 is a side view of the IOL system, as depicted in FIG. 4; and

FIG. 6 is a perspective view of a preferred embodiment of the AIOL blank of the invention;

FIG. 7 is a plan view of FIG. 6;

FIG. 8 is a perspective view of a mold insert with handle with the AIOL blank shown in spaced relation thereto; and

FIG. 9 is a side elevational view of the mold insert and handle.

### DETAILED DESCRIPTION

Referring to FIG. 1 there is seen a partial cross-sectional view of an anterior segment of a human eye 20. Vision in humans is provided by a first convex/concave IOL known as a cornea 22. This segment is partially spherical and is transparent to light. The cornea 22 is connected at its perimeter to a generally spherical exterior body of the eye known as a sclera 24. An iris 26 is positioned within an anterior chamber of the eye 28 and serves to vary the amount of light permitted to pass into the eye structure. The iris 26 extends into and is joined with the ciliary body or muscle 30 which extends peripherally about an interior portion of the eye. The eye's natural crystalline lens 32 is positioned behind the iris 26 and is surrounded by a capsular membrane or bag 34. The natural crystalline lens 32 approximates an ellipse in cross-section and is circular when viewed along a line of sight. Zonula 36 extend between the ciliary muscle 30 and an equator position of the capsular bag 34. A hyloid face, not shown, extends across the posterior surface of the lens 32 and isolates the forward segment of the eye from a vitreous chamber filled with clear vitreous humor.

Light is focused by the human eye by being refracted through the cornea and then refracted again through the bi-convex natural crystalline lens and is focused on a retina at the back of the eye. Vision from infinity to 250 millimeters is accommodated by varying the shape of the natural crystalline lens 32. More specifically, images at infinity are focused by the ciliary muscle 30 relaxing which permits their peripheral expansion and thus tensioning the zonula 36. Tension of the zonula draws the equator of the capsular bag radially outward and foreshortens the thickness of the lens 32, providing for distance vision. In contrast, near vision is accommodated in a human eye by the ciliary muscles contracting which releases tension on the zonula allowing the lens 32 to thicken into its natural state and thus focusing near objects upon the retina for transmission to the brain by the optic nerve.

A human eye adapts readily to variations in focal length and seamlessly enables a human to view objects at infinity as well as near vision instantly without conscious accommodation. Notwithstanding the perfect vision enjoyed by a majority of the population, an inability to view objects at infinity, or myopia, is frequently encountered. This visual impairment can be corrected by refractive lenses held by frames (spectacles), wearing contact lenses, or refractive surgery. In addition, certain humans do not focus near vision well. This is known as hyperopia and their vision can also be corrected by conventional refractive techniques. In certain instances of severe lack of accommodation these conventional procedures become undesirable and alternative procedures are needed. Although a youth of ten years in age has an ability to change the diopter power by fourteen diopters, this ability gradually decreases with age and by fifty or so the ability of the human eye to accommodate variation in focal length becomes essentially zero. This condition is referred to as presbyopia and a patient often requires correction for both near and far vision. This can be achieved by wearing bifocal glasses or contacts or undergoing refractive surgery for distance and wearing glasses for reading purposes.

In addition to the foregoing more conventional limitations on 20/20 vision in instances of juvenile disease, trauma, and more frequently through age, the natural crystalline lens 32 becomes rigid and opaque to the passage of light. This condition is referred to as a cataract which can be corrected by removal of the lens 32 by a number of techniques, however, the most commonly performed surgery is known as extracapsular extraction. In this procedure, an annular opening in the capsular bag 34 is fashioned about the anterior visual center of the lens, centered by the iris, and then emulsifying and aspirating the hardened lens material. At least one procedure for phacoemulsification, irrigation and aspiration, is disclosed in a U.S. Pat. No. 5,154,696. Once the natural crystalline lens is removed, a bi-convex, fixed focal length optic, of about six millimeters in diameter, is typically fitted into the capsular bag and held in position by radially extending haptics. Although cataract surgery and insertion of an IOL is the most frequently performed surgical procedure in the United States and has achieved a considerable degree of sophistication and success, the IOL is selected with a diopter to achieve for distance vision and near vision must be corrected by wearing reading glasses.

Finally, retinal disease or damage can impair human vision and one form is known as macular degeneration which usually occurs with advance in age. The symptom of macular degeneration can be alleviated, to a degree, by providing high diopters in the 30 to 70 range such that the rods and cones available to receive sight are utilized to their fullest.

From the foregoing context it will be appreciated that improvements in the eye care industry can be made with respect to correction of vision such as hyperopia presbyopia, replacement of vision following cataract extraction and treatment of retinal dysfunction such as macular degeneration.

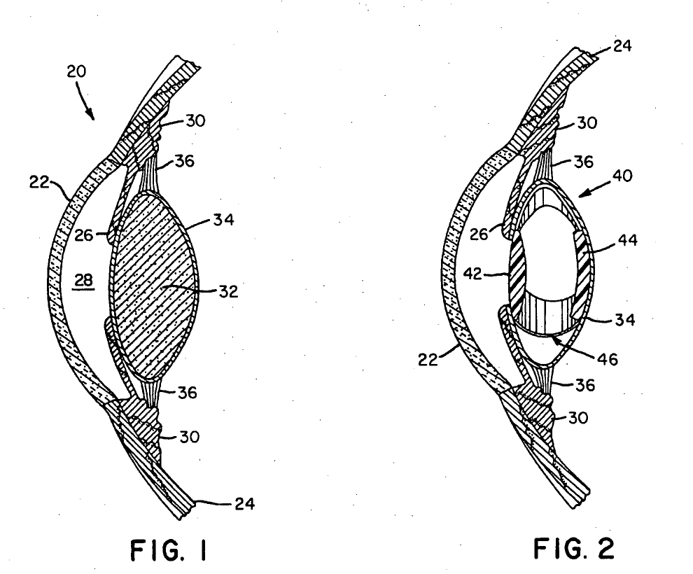

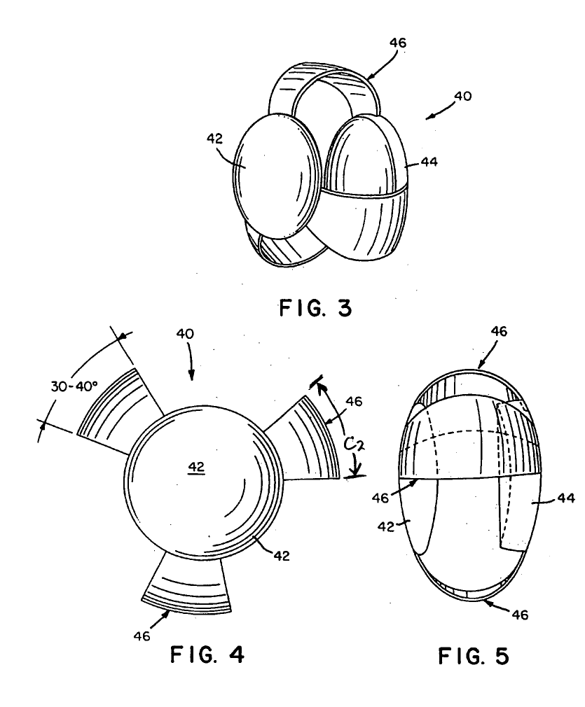

Referring now to FIG. 2, the subject invention is directed to methods and assemblies providing for the manufacture of an open chamber, accommodating, IOL system (hereinafter “AIOL”) which is operable to correct and/or eliminate vision impairments of the type described above. The IOL system 40 seen in FIG. 2 includes an anterior optic 42, a posterior optic 44 and one or more haptic segments 46 interconnecting the anterior optic 42 with the posterior optic 44. As noted in FIG. 2, the IOL system 40 may be substantially elliptical in cross-section and conforms to the interior three-dimensional surface of the capsular bag 34. Turning to FIGS. 3-5, there is shown an exemplary embodiment of the AIOL system 40 which may be manufactured according to the inventive methods and assemblies described and claimed herein. It is thus understood that the present invention may be utilized to manufacture other configurations of AIOLs, so long as they include at least first and second optics interconnected by at least one haptic.

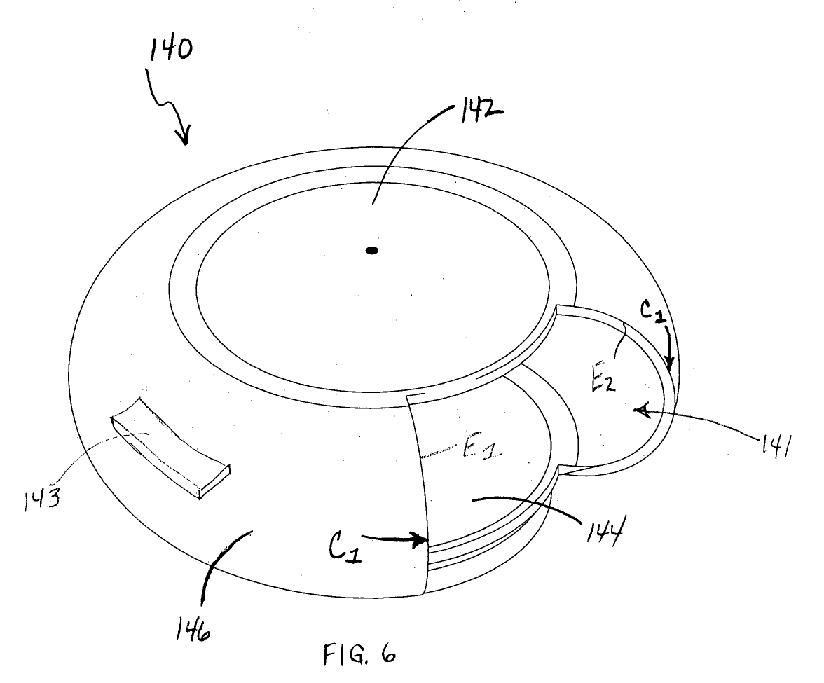

The forward or anterior optic 42 is preferably bi-convex as depicted in FIG. 5 and has a diameter of approximately five millimeters for positioning within a capsular bag 34 immediately behind the iris 26. The power distribution of the anterior and posterior optics may be varied to suit the needs of the particular patient, however, in a preferred embodiment, the anterior optic is positive and the posterior optic is negative. The posterior optic 44 is in visual, axial alignment with the anterior optic 42 and cooperates with the anterior optic to correct a wearer's vision. In a preferred embodiment, the optic 44 is fashioned in a spherical concavo-convex shape as depicted in FIGS. 3 and 5. Although in a preferred embodiment the anterior and posterior optic combinations are as stated above, other optic couples are contemplated by the subject invention including an anterior optic fashioned with concavo-planar, concavo-convex, and convex-concavo configurations. In a similar manner, the posterior optic may also exhibit the range of physical optic formation possibilities such as concavo-planar, concavo-convex, and convex-concavo in order to achieve the desired visual result for a particular patient. IOLs are made from a variety of hard and soft materials such as polymethylmethacrylate (PMMA), silicone, and acrylics, provided visual clarity, refractive ability, and bio-compatibility are all maintained.

In one exemplary accommodating IOL system 40, the anterior optic 42 and posterior optic 44 are coupled together by at least one, but preferably a plurality of haptics 46 extending therebetween. The haptics are connected to the peripheral edges of the anterior and posterior optics and are positioned around the peripheral edges of the optics in substantially equidistant peripheral locations. In a preferred embodiment, the haptics subtend an angle of thirty to forty degrees as viewed in a direction of line of sight, (see FIG. 4), and extend outwardly approximately nine millimeters, in diameter, to approximate the normal internal diameter of the capsular bag of the human eye. In cross-section, the haptics 46 are arcuate, and have a radius of curvature of approximately 4.5 millimeters which enables the haptic to smoothly conform to the interior surface of an evacuated capsular bag. Although three radially extending haptics covering arcs of 30-40 degrees each, such as shown in FIGS. 2-5, constitute a preferred embodiment of the invention, other haptic arrangements of from one to five or more in number are envisioned and can be selected by those of ordinary skill in the art to satisfy the requirement of sufficient flexibility to provide the accommodated focusing of the IOL system and simultaneous stiffness to maintain the axial position and orientation of the IOL optics.

Discussion is now turned to the inventive methods and assemblies provided for the manufacture of an AIOL having first and second optics interconnected by at least one haptic.

Referring to FIG. 6, a semi-finished AIOL blank 140 is provided from which a finished AIOL, such as exemplary AIOL system 40, may be fabricated. As stated above, it is understood that the present invention is equally applicable to non-accommodative IOLs of the single or multiple optic designs.

According to a first aspect of the present invention, a method of manufacturing an AIOL having first and second optics and at least one finished haptic extending therebetween is provided. The method comprises the steps of forming the first and second optics with a semi-finished haptic extending therebetween which is larger than the finished haptic or haptics. The finished haptics are formed by removing a portion of the semi-finished haptic or haptics. This manufacturing method allows a semi-finished AIOL 140 to be initially formed from which a variety of differently sized and shaped finished haptics may be formed. This increases efficiencies in manufacturing in that a single mold tool may be used to create the semi-finished AIOL 140 from which the finished AIOL 40 is made. In other words, separate mold tools need not be made for each haptic size and configuration being manufactured.

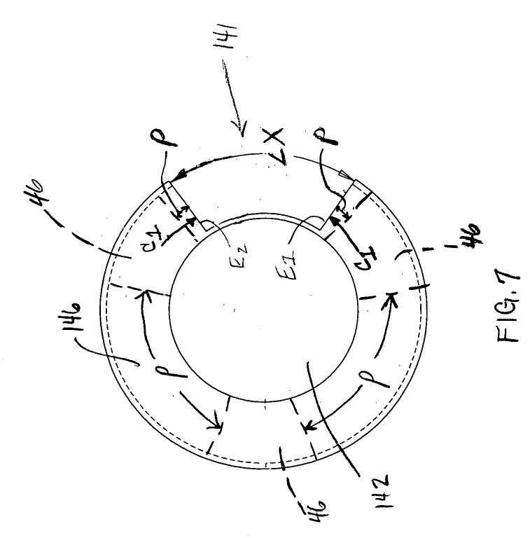

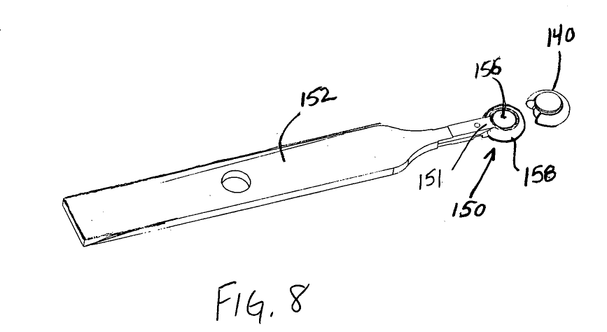

Thus, in a preferred embodiment, the manufacture of an AIOL system such as AIOL system 40 begins with forming an AIOL blank 140 having first and second optics 142, 144 interconnected by at least one semi-finished haptic 146. The semi-finished haptic 146 has a circumference C1 (FIGS. 6 and 7) which is larger than the corresponding circumference C2 (FIG. 4) of the finished haptic or haptics 46. As such, one or more portions P of the semi-finished haptic 146 may be removed as indicated between the dashed lines in FIG. 7, leaving the finished haptics 46 interconnected between the first and second optics 12, 14. The material removal process may be carried out by any known or yet to be discovered technique, present examples of which include laser removal, abrading, milling and cutting.

In another aspect, the present invention provides an AIOL blank 140 having first and second optics 142, 144 interconnected by at least one semi-finished haptic or haptics 146 larger than the finished haptic or haptics 46 of the finished accommodating AIOL 40. The semi-finished haptic or haptics 146 of the AIOL blank 140 may be cut or otherwise reduced in area to achieve the desired finished haptic size and shape.

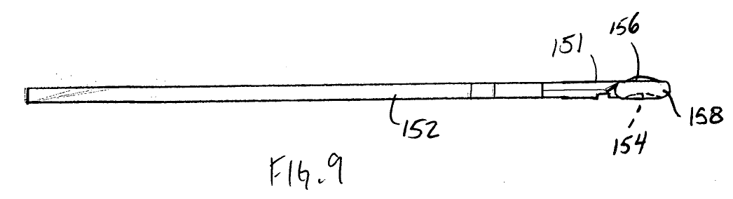

In yet another aspect, the invention provides an assembly comprising a mold insert 150 and an AIOL blank 140 formed about the insert 150 (FIG. 8). The insert 150 may or may not include a handle 152 and be part of an injection mold core (not shown) for molding an AIOL blank 140 having first and second optics 142, 144 with at least one semi-finished haptic 146 extending between the first and second optics. The mold insert 150 includes first and second optical surfaces 154, 156 for forming the facing surfaces of the first and second optics 142, 144 of the AIOL blank, respectively. The semi-finished haptic 146 or haptics of the AIOL blank extend about the insert 150 and interconnect the first and second AIOL blank optics 142, 144. Thus, the surface 158 of the insert 150 extending between the first and second optical surfaces 154, 156 thereof form the inside surfaces of the IOL haptic 146 or haptics. The mold core in which the mold insert is positioned forms the remaining surfaces of the AIOL blank. In a preferred embodiment, the mold insert 150 is part of an injection mold core such as disclosed in pending application Ser. No. 10/445,762 filed May 27, 2003 (the Sarfarazi mold application), the entire disclosure of which is incorporated herein by reference.

After introducing and curing of the mold material in the mold cavity, the mold is opened and the mold insert 150 is removed therefrom with the AIOL blank 140 formed about and remaining with the insert 150. If desired, the mold insert 150 may thereafter be used as a fixture for holding the AIOL blank 140 when performing any desired subsequent AIOL processing operations on the AIOL blank 140 (e.g., cutting of the haptics into their finished form, polishing, extraction, hydration, inspection etc.). At any desired stage, the AIOL blank 140 may be removed from the mold insert 150 (i.e., before or after one or more subsequent processing steps (see FIG. 8)). This may be done by carefully stretching the AIOL made of soft material (e.g., silicone) off of the insert 150, for example, by retracting mold insert 150 through molded-in opening 141 formed by handle neck 151 (see FIGS. 8 and 9). In this regard, it is noted that the angle “X” of opening 141 extending between the edges E1, E2 of the semi-finished haptic 146 (see FIGS. 6 and 7) should be large enough to allow the AIOL blank 140 to be stretched off the insert 150 without imparting damage thereto. Angle X may be between about 50 and 90 degrees, more preferably is between about 60 and 80 degrees, and most preferably is about 70 degrees. Other possible IOL/mold insert separation techniques include deforming, collapsing or destroying (sacrificing) the mold insert itself, leaving the AIOL intact and unharmed. In this regard, the mold insert may be made from a variety of one or more materials acceptable for this purpose. Alternatively, the semi-finished haptic may not include a molded-in opening, but rather an opening such as opening 141 is cut into a completely closed semi-finished haptic (extending 360 degrees about and thus completely encapsulating the mold insert) while the AIOL is still on the mold insert. A completely closed semi-finished haptic would be similar to that depicted in FIGS. 6 and 7 except opening 141 is not initially molded-in but is rather subsequently cut into the semi-finished haptic. In this embodiment, the mold insert need not be attached to a handle. The AIOL may then be stretched off the mold insert by retracting the mold insert through the cut opening.

If desired, one or more tabs such as tab 143 seen in FIG. 6, may be provided on the exterior surface of semi-finished haptic 146 to assist in handling the AIOL blank 140. The tab or tabs 143 may be molded-in and subsequently removed when removing portions of the semi-finished haptic to form the finished haptic(s).

It is noted that the invention is applicable to single optic IOLs as well as dual optic IOLs. In this embodiment, a single optic having one or more haptics attached thereto (e.g., in the shape of haptics 46) would be molded on the mold insert and easily removed therefrom by pulling the optic away from the mold insert. The handle could still be provided on the mold insert for ease of handling the insert and IOL together during subsequent processes such as those discussed above. As in previous embodiments, a semi-finished haptic larger than the finished haptic(s) may be molded and thereafter reduced in size to form the finished haptic(s).

What is claimed is:

1. A method of manufacturing an IOL having first and second optics and at least one finished haptic extending between said first and second optics, said method comprising the steps of:
a) forming said first and second optics with at least one semi-finished haptic extending therebetween, said at least one semi-finished haptic being larger than said at least one finished haptic;
b) removing a portion of said at least one semi-finished haptic to form said at least one finished haptic.

2. The method of claim 1 wherein said removing step is performed with a laser.

3. The method of claim 1 wherein said removing step is performed with a cutting instrument.

4. The method of claim 1 wherein said removing step is performed with a milling instrument.

5. The method of claim 1 wherein said removing step is performed with an abrading instrument.

6. The method of claim 1 wherein said forming step is performed by injection molding.

7. The method of claim 1 wherein said forming step is performed by cast molding.

8. The method of claim 1 wherein said forming step utilizes a mold insert about which said IOL is molded.

9. The method of claim 8 wherein an opening is molded into said semi-finished haptic and wherethrough said mold insert is retracted to remove said IOL off of said mold insert.

10. The method of claim 9 wherein mold insert is attached to handle which forms said opening.

11. The method of claim 8 wherein said semi-finished haptic extends 360 degrees about said mold insert and an opening is cut into said semi-finished haptic wherethrough said mold insert is retracted to remove said IOL off of said mold insert.

12. The method of claim 1 wherein said at least one semi-finished haptic includes at least one tab to assist in handling said IOL during the manufacture thereof.

13. The method of claim 12 wherein said at least one tab is integrally formed with said at least one semi-finished haptic.

14. The method of claim 13 wherein said at least one tab is removed when forming said at least one finished haptic.

15. The method of claim 1 wherein said at least one semi-finished haptic has a circumference extending between an angle of about 200° to about 310°.

16. The method of claim 15 wherein said angle is about 2900.

17. The method of claim 1 wherein at least two finished haptics are formed from said at least one semi-finished haptic.

18. The method of claim 1 wherein three finished haptics are formed from said at least one semi-finished haptic.

19. The method of claim 18 wherein said three finished haptics are substantially equally spaced from each other.

20. An assembly for manufacturing an IOL having first and second optics and at least one finished haptic extending between said first and second optics, said assembly comprising:
a) a mold insert having first and second opposing surfaces; and
b) a semi-finished accommodating IOL having first and second optics and at least one semi-finished haptic extending therebetween, said semi-finished IOL being positioned about said mold insert with said first and second optics positioned adjacent said first and second surfaces of said mold insert.
whereby a portion of said at least one semi-finished haptic may be removed to form said at least one finished haptic.

21. The assembly of claim 20 wherein said IOL is injection molded about said mold insert.

22. The assembly of claim 20 wherein said IOL is formed of silicone.

23. A method of manufacturing an IOL having at least one optic and at least one finished haptic extending therefrom, said method comprising the steps of:
a) providing a mold insert;
a) forming said at least one optic with at least one semi-finished haptic extending therefrom about said mold insert, said at least one semi-finished haptic being larger than said at least one finished haptic;
b) removing a portion of said at least one semi-finished haptic to form said at least one finished haptic.

24. The method of claim 23 and further comprising a handle attached to said mold insert.

25. An assembly for manufacturing an IOL having at least one optic and at least one finished haptic extending therefrom, said assembly comprising:
a) a mold insert having first and second opposing surfaces; and
b) a semi-finished IOL having at least one optic and at least one semi-finished haptic extending therefrom, said semi-finished IOL being positioned about said mold insert with said at least one optic positioned adjacent said first surface of said mold insert;
whereby a portion of said at least one semi-finished haptic may be removed to form said at least one finished haptic.
